(19) United States
(12) Patent Application Publication
(10) Pub. No.: US 2014/0154536 A1
(43) Pub. Date: Jun. 5, 2014

(54) METHODS AND DEVICES FOR DETECTING VENTING OF A BATTERY CELL

(71) Applicant: FORD GLOBAL TECHNOLOGIES, LLC, Dearborn, MI (US)

(72) Inventors: THOMAS J. COUPAR, ANN ARBOR, MI (US); ALLEN JOSEPH GILBERT, GROSSE ILE, MI (US)

(73) Assignee: FORD GLOBAL TECHNOLOGIES, LLC, DEARBORN, MI (US)

(21) Appl. No.: 13/693,914

(22) Filed: Dec. 4, 2012

(51) Int. Cl. H01M 10/48; H01M 2/12

(52) U.S. Cl. CPC H01M 10/488; H01M 2/1241; H01M 2/1288
USPC 429/56; 429/82

(57) ABSTRACT

A vehicle may include an electric machine, a battery adapted to provide power to the electric machine, and various embodiments of a gauge adapted to indicate venting of the battery. In one embodiment, the gauge is adapted to permanently deform or burst in response to venting of the battery to indicate venting of the battery. In another embodiment, the gauge includes an element adapted to change position in response to venting of the battery to indicate venting of the battery. In other embodiments, the gauge includes either a universal paper indicator or a chemically coated cartridge indicator in communication with the battery and adapted to change in color to indicate venting of the battery.

### TECHNICAL FIELD

This disclosure relates to devices for indicating the venting of a battery cell.

### BACKGROUND

Hybrid vehicles typically include a high voltage battery pack adapted to provide power to various components of the vehicles, including motors, transmissions, and electrical accessories. A battery pack may be a lithium ion battery, such as a nickel metal hydride or a nickel cadmium battery. The battery pack may include multiple cells connected in series. Each cell may include a cathode, an anode, and an electrolyte. The electrolyte is a medium that allows the electrical charge to flow between the anode and the cathode. It is the electromagnetic reactions that occur within the cell that allows a battery pack to serve as an energy source.

The performance of the battery packs often needs to be checked, as they may degrade overtime from frequent use. Certain batteries may need to be monitored for overcharging. A lithium-ion battery, for instance, may completely be ruined once overcharged. Once overcharged and depleted, they may cause an electrical short, which may ruin certain electronic devices. When the batteries are overcharged or when they are substantially depleted, one or more of their cells typically have vented. Depending on the battery type, cell venting may be characterized by the cell being pressured, discharge of gases from the cell, such as hydrogen, or propulsion of the electrolyte out of the cell. Batteries typically include vent ports to accommodate the pressure, gas release, or electrolyte being propelled out of the cells.

### SUMMARY

A vehicle is provided that includes an electric machine, a battery adapted to provide power to the electric machine, and a gauge adapted to change its physical appearance in response to venting of the battery to indicate venting of the battery.

A vehicle is provided that includes an electric machine, a battery adapted to provide power to the electric machine, and a pressure sensitive gauge adapted to provide a visible response to pressure associated with venting of the battery to indicate venting of the battery.

A vehicle is provided that includes an electric machine, a battery adapted to provide power to the electric machine, and a chemically sensitive gauge adapted to chemically respond to venting of the battery to indicate venting of the battery.

### BRIEF DESCRIPTION OF THE DRAWINGS

FIG. 1 is a schematic view of an environment showing a battery cell venting indicator is used.

FIG. 2 is a schematic view of an exemplary embodiment of a battery cell venting indicator.

FIG. 3 is a perspective view of a battery with the battery cell venting indicator embodiment of FIG. 2.

FIG. 4 is a schematic view of another exemplary embodiment of a battery cell venting indicator.

FIG. 5 is a perspective view of yet another exemplary embodiment of a battery cell venting indicator.

FIG. 6 is a schematic view of another exemplary embodiment of a battery cell venting indicator.

FIG. 7 is a schematic view of yet another exemplary embodiment of a battery cell venting indicator.

FIG. 8 is a schematic view of the battery cell venting indicator of FIG. 7 indicating the venting of a battery cell.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The present disclosure includes various embodiments of battery cell venting indicators, which may be used for various batteries and environments where batteries are commonly used as a power source, including hybrid vehicles. The various embodiments of the battery cell venting indicators may be used in battery test facilities or laboratories where battery packs may be stored without electronic monitoring and where battery packs are not attached to vehicles. Some embodiments may include pressure sensitive gauges that provide a visible response to battery venting, chemically sensitive gauges that provide a chemical response to battery venting, or gauges that change in physical appearance in response to battery venting. The disclosure may be referring to batteries for hybrid vehicles, or vehicle applications, to provide exemplary applications and to aid in the clarity of the descriptions. However, the various embodiments of the present disclosure are not limited to a certain battery type. The various embodiments of the present disclosure are also not limited to automotive applications.

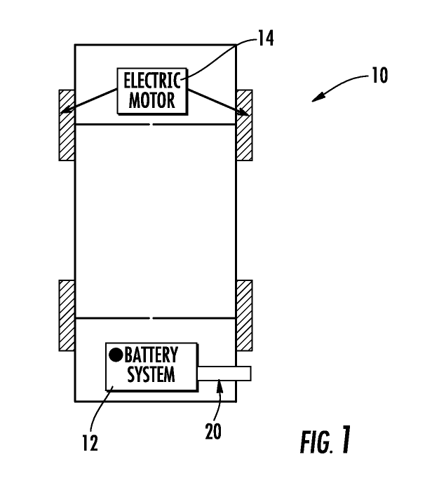

Referring now to FIG. 1, a schematic diagram of a vehicle 10 is shown wherein the vehicle 10 includes a battery system 12 that is connected to an electric machine 14, which may be an electric motor and/or various electrical components of the vehicle. The battery system 12 preferably includes a battery cell venting indicator 20 configured to indicate venting of the cell of the battery system 12. The battery cell venting indicator 20 may be made such that its components are inside the vehicle 10, or it may be made such that at least some of its components may be visible from the exterior of the vehicle 10.

In hybrid vehicles, battery packs are typically sealed. They may also be secured in the rear of the vehicles and covered by vehicle upholstery. When their performance conditions need to be checked, it is desirable to determine whether the battery cells have vented without having to perform substantial disassembly of the vehicle upholstery or mounts that secure the battery packs. Even if a battery pack is not covered, such as by vehicle upholstery, or even if the battery pack is not attached to a vehicle, it is desirable to have an external indicator that would allow one to visually determine whether the cells have vented without having to break the battery seal, as breaking the battery seal may compromise the battery. Where the battery is in a repair facility, a laboratory, or in a similar place, a visual battery cell venting indicator may save a technician from being exposed to hazardous materials resulting from cell venting. It can be appreciated that the battery cell venting indicator 20 may provide these advantages.

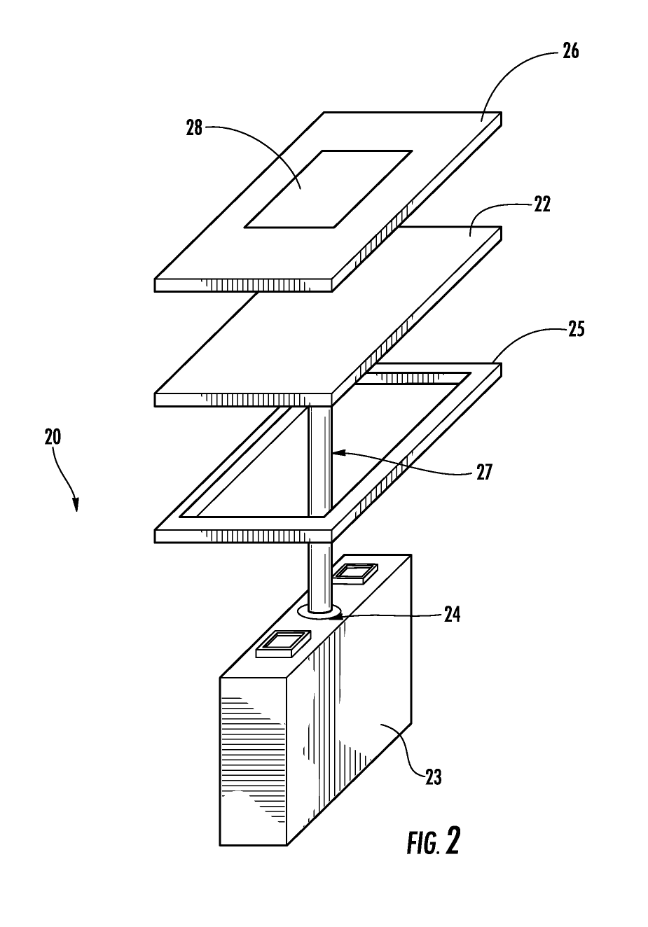

In FIG. 2, a battery cell venting indicator embodiment 20 is shown and includes a universal paper indicator 22 positioned substantially adjacent to a vent port 24 of a battery cell 23. The universal paper indicator 22 is preferably adapted to be in the path of the electrolyte that is anticipated to be propelled through the vent port 24 when the battery cell 23 vents. When the battery cell 23 vents, the universal paper indicator 22 is adapted to catch the electrolyte and change in color, depending on the pH of the electrolyte. The universal paper indicator 22 may be in a form of an absorbent material impregnated with a universal indicator, such as commonly known dyes, adapted to chemically respond to the electrolyte. The universal paper indicator 22 may be a pH paper, a litmus paper, or a treated filter paper.

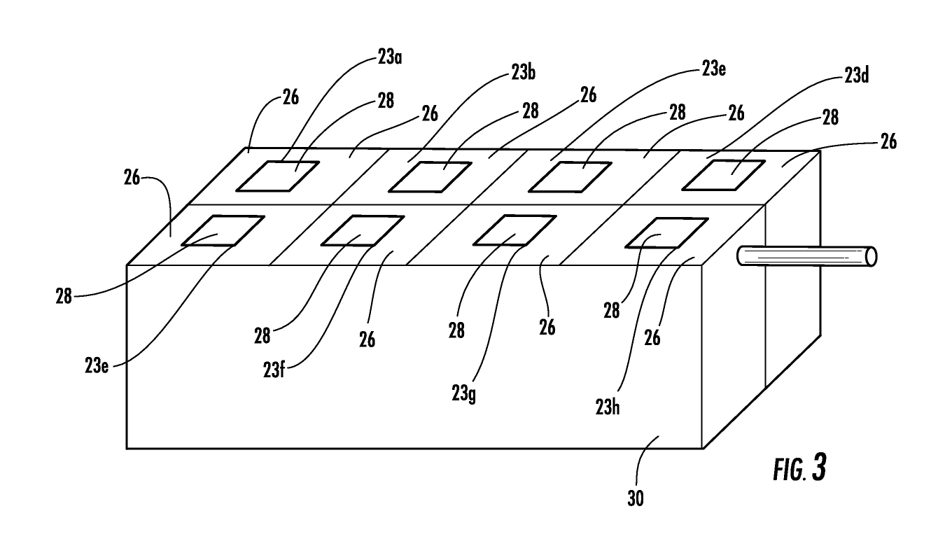

The universal paper indicator 22 is preferably mounted adjacent to the vent port 24 by a bottom frame 25 adapted to hold the bottom portion of the universal paper indicator 22. A top frame 26 with a transparent portion or window 28 is preferably positioned at the top portion of the universal paper indicator 22. The universal paper indicator 22 held by the top frame 26 and the bottom frame 25 may be mounted to a battery housing (not shown on FIG. 2). The vent port 24 may optionally be extended by attaching a tube 27 to properly align the top frame 26, the universal paper indicator 22, and the bottom frame 25 with the battery housing.

Where the battery includes multiple cells 23a-23h, as shown in FIG. 3, each cell preferably includes the components 22, 25, 26, and 28 of the battery cell venting indicator embodiment 20. These components are preferably attached to the battery housing 30. By looking at FIG. 3, it can be realized that, with the battery cell venting indicator embodiment 20, a battery can be checked for cell venting by simply looking at the exterior of the battery or the transparent portions or windows 28 of each cell for changes to the physical appearance of the universal paper indicator or to see if there are any color changes. The venting of the battery cells can be checked without having to break any battery seals or housing.

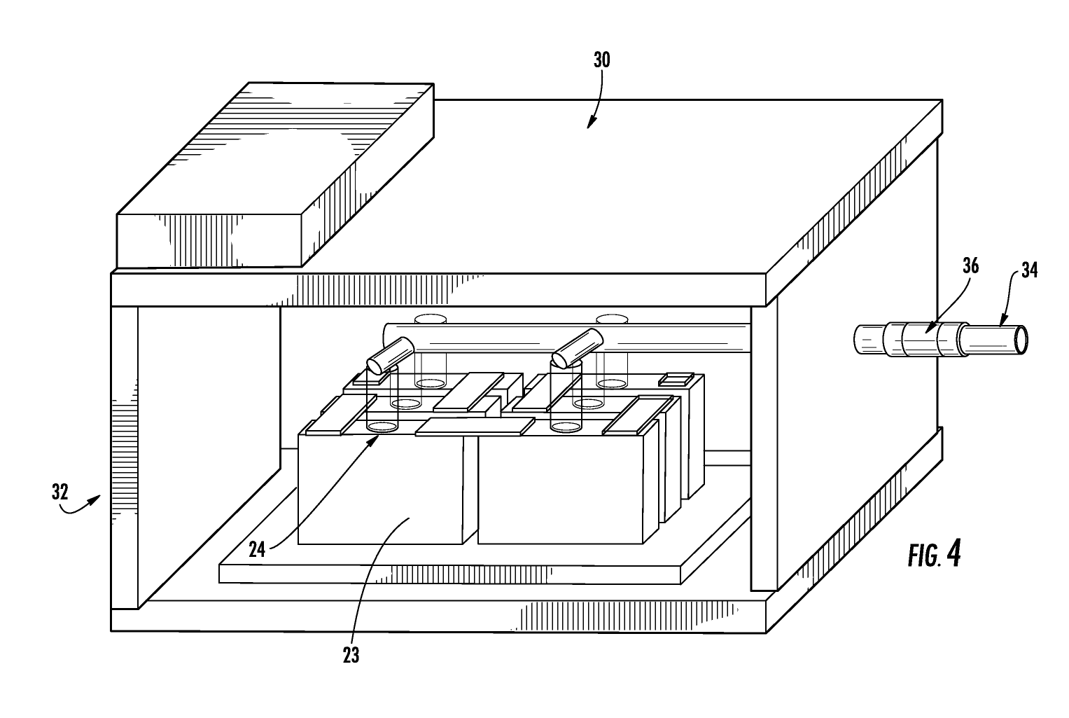

Referring now to FIG. 4, another battery cell venting indicator embodiment 32 is shown and preferably includes a tube 34 attached to the vent port 24 and extends out of the battery housing 30. The tube 34 is preferably transparent, may be a single piece or may be made of multiple pieces, and may be of various shapes. A portion of the tube 34 is preferably positioned inside the battery housing 30, and a portion of the tube 34 is preferably positioned outside the battery housing 30. Outside the battery housing 30, a universal paper indicator 36 is preferably positioned within the interior of the tube 34. The universal paper indicator 36 is preferably designed to catch the electrolyte (not shown) to be propelled out of the battery cell 23 through the vent port 24 when the battery cell 23 vents. Once the electrolyte comes in contact with the universal paper indicator 36, the universal paper indicator 36 is adapted to change in color to indicate that the battery cell has vented.

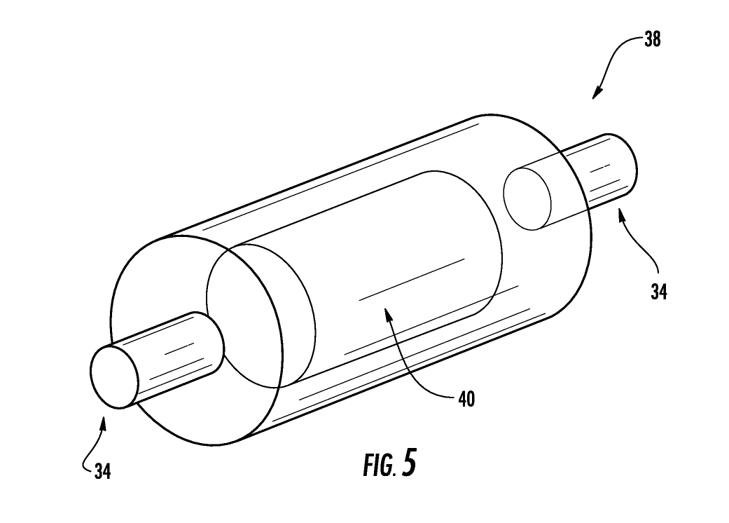

Referring now to FIG. 5, yet another embodiment 38 of a battery cell venting indicator is shown. Embodiment 38 may be similar to battery cell venting indicator embodiment 32 except that instead of using the universal paper indicator 36 to indicate venting of the battery cell 23, embodiment 38 preferably utilizes a chemically coated cartridge 40 adapted to chemically react to certain gases being dislodged from the vent port 24. The chemically coated cartridge 40 may be made of gas permeable matrix coated with chemochromic compositions, such as TiO2 supported PdO pigments as disclosed in U.S. patent application Ser. No. 11/414,900. When the cell vents, the cell will discharge hydrogen gas. When the hydrogen gas reaches the cartridge 40, the chemochromic compositions of the cartridge 40 is preferably adapted to chemically react to hydrogen by causing the gas permeable matrix to discolor. Thus, it can be appreciated that the venting of the cell can be detected by just observing the changes in the physical appearance of the chemically coated cartridge 40 and without breaking the battery seals or housing.

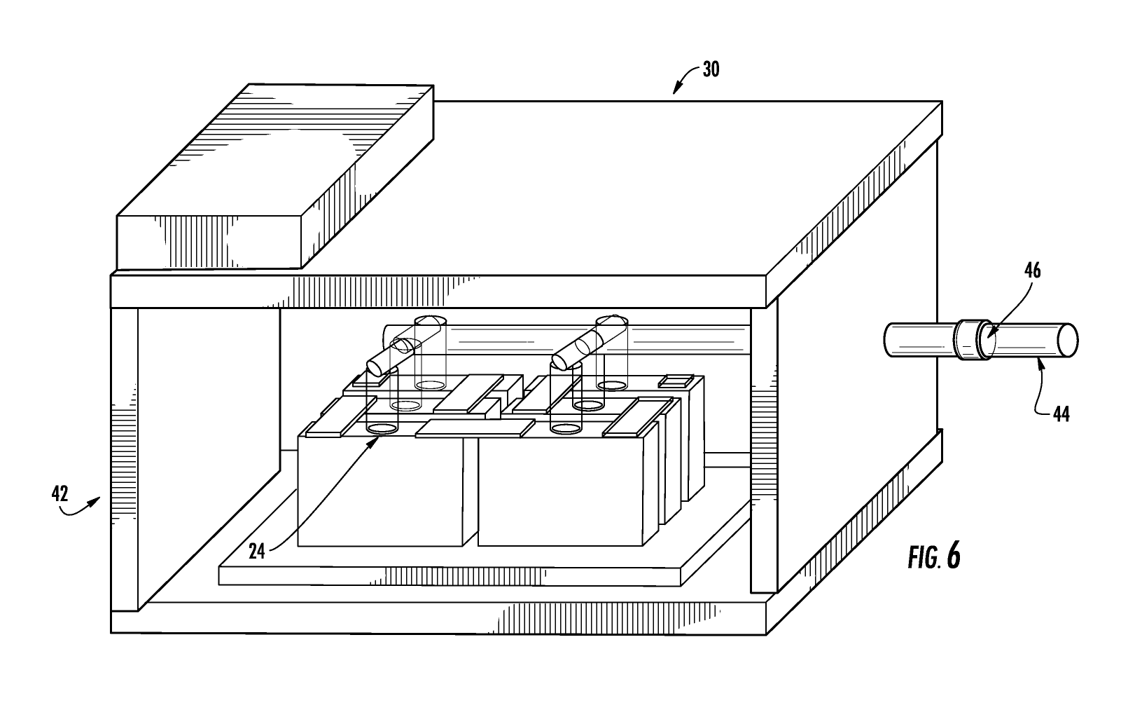

With reference now to FIG. 6, yet another battery cell venting indicator embodiment 42 is shown. Battery cell venting indicator embodiment 42 preferably includes a tube 44 that is similar to tube 34 and attached to the vent port 24. The tube 44 preferably extends out to the exterior of the battery housing 30. A deformable member 46 is preferably positioned inside the tube 44 at a portion of the tube that is outside the battery housing 30. The deformable member 46 may be made out of a polymer, such as a film or plastic, which may preferably permanently deform or burst when subjected to a predetermined amount of pressure within the battery cell. As the battery cell 23 vents, the battery cell 23 will be pressurized. The pressure will be vented through the vent port 24. A predetermined amount of pressure will cause the deformable member 46 to visibly change in shape or burst. Thus, the tube 44 and the shape of the deformable member 46 can simply be viewed to see if the battery cell 23 has vented. The battery seals or housing need not be broken to see if the battery cell 23 has vented.

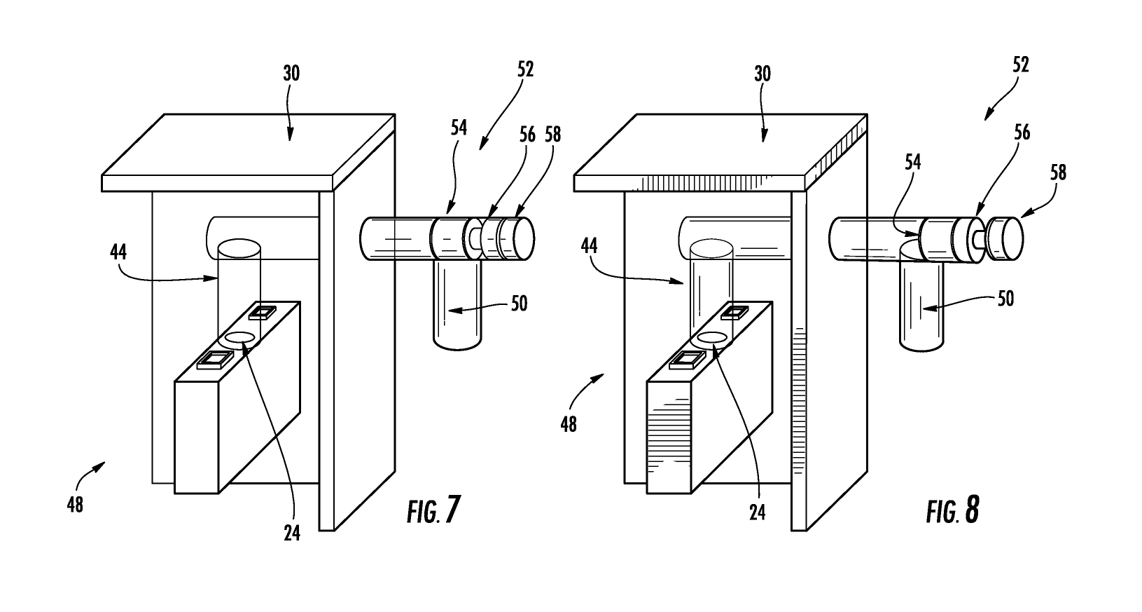

Referring now to FIGS. 7 and 8, another battery cell venting indicator embodiment 48 is shown. Battery cell venting indicator embodiment 48 is preferably similar to battery cell venting indicator embodiment 42 except that the tube 44 may be modified to include a perpendicular extension 50 and the deformable member 46 is replaced by a moveable member 52 adapted to move from one physical location to another. The moveable member 52 may include base 54, a collar 56 attached to the base 54, and a plunger 58 that may move from a position next to the collar 56 to a position away from the collar 56. As the battery cell 23 vents, a predetermined amount of cell pressure will push the moveable member so the pressure can go through the perpendicular extension 50. The cell pressure will move the base 54 and the collar 56 towards the end of the tube 44. The plunger 58 preferably exits the tube 44 but remains attached to the collar 56. Thus, the venting of the battery cell can be detected by the position of the moveable member 52 having been moved to a position past the perpendicular extension 50 of the tube 44, or the plunger 58 having been displaced out of the tube 44.

It is noted that the tubes 34 or 44 that are attached directly to the cell vent port may be optional. Certain battery cells may have built-in vent channels, or vent channels may be created within battery cells. The various gauges or indicators, such as the universal paper indicator, the chemically coated cartridge, the deformable member, or the moveable member, may be operatively connected to these vent channels so they can receive the electrolyte, gas, or pressure and indicate cell venting, as previously described.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
an electric machine;
a battery configured to provide power to the electric machine; and
a gauge configured to change its physical appearance in response to venting of the battery to indicate venting of the battery.

2. The vehicle of claim 1, wherein the gauge is configured to deform or burst in response to the venting of the battery to indicate venting of the battery.

3. The vehicle of claim 1, wherein the gauge is configured to change its color in response to the venting of the battery to indicate venting of the battery.

4. The vehicle of claim 1, wherein the gauge is configured to change its physical location in response to venting of the battery to indicate venting of the battery.

5. The vehicle of claim 1, wherein the gauge comprises a collar and a plunger moveably connected to the collar and wherein the plunger is configured to move away from the collar in response to venting of the battery to indicate venting of the battery.

6. The vehicle of claim 1, wherein the gauge comprises a universal paper indicator.

7. The vehicle of claim 1, wherein the battery includes a cell configured to discharge hydrogen when venting and wherein the gauge comprises a gas permeable matrix coated with chemochromic pigment configured to change color in the presence of hydrogen gas.

8. The vehicle of claim 1, wherein the battery includes at least one cell and a housing encasing the cell and wherein the gauge is disposed outside of the housing.

9. A vehicle comprising:
an electric machine;
a battery configured to provide power to the electric machine; and
a pressure sensitive gauge configured to provide a visible response to pressure associated with venting of the battery to indicate venting of the battery.

10. The vehicle of claim 9, wherein the gauge is configured to deform or burst in response to venting of the battery to indicate venting of the battery.

11. The vehicle of claim 9, wherein the battery includes a vent port and at least one cell configured to vent via the vent port and wherein the gauge is fitted to the vent port.

12. The vehicle of claim 9, wherein the gauge comprises a film.

13. The vehicle of claim 9, wherein the gauge comprises a collar and a plunger moveably connected to the collar and wherein the plunger is configured to move away from the collar in response to venting of the battery to indicate venting of the battery.

14. The vehicle of claim 9, wherein the gauge includes an element configured to change position in response to venting of the battery to indicate venting of the battery.

15. A vehicle comprising;
an electric machine;
a battery configured to provide power to the electric machine; and
a chemically sensitive gauge configured to chemically respond to venting of the battery to indicate venting of the battery.

16. The vehicle of claim 15, wherein the battery includes a cell filled with electrolyte, wherein during venting of the battery, the electrolyte propels out of the cell, and wherein the gauge comprises a universal paper indicator arranged to catch the electrolyte and configured to change color to indicate venting of the battery.

17. The vehicle of claim 16, further comprising a battery housing encasing the battery and including a throughway in registration with the universal paper indicator.

18. The vehicle of claim 15, wherein the battery includes a cell configured to discharge hydrogen gas during venting of the battery and wherein the gauge comprises a gas permeable matrix coated with chemochromic pigment configured to change color in the presence of hydrogen gas.
